(19) United States
(12) Patent Application Publication
(10) Pub. No.: US 2015/0349504 A1
(43) Pub. Date: Dec. 3, 2015

(54) Faceplate and hanging device

(71) Applicant: Craig Allison, Scarborough (CA)

(72) Inventor: Craig Allison, Scarborough (CA)

(21) Appl. No.: 14/120,492

(22) Filed: May 27, 2014

(51) Int. Cl. H02G 3/08; F16M 13/02

(52) U.S. Cl. CPC H02G 3/081; F16M 13/02

(57) ABSTRACT

The faceplate and hanging hook device includes at least one hanging hook integrally formed on a front surface portion of the plate. The plate is mountable to an electrical device securely mounted to a wall-mounted connection box which is securely mounted to a stud of a building. The device serves both as a faceplate for covering the electrical connection box as well as a secure hanging means located at a desirable convenient location in the building.

### TECHNICAL FIELD

This invention relates to a hanging hook device which can be securely mounted to a building wall without damaging the wall and requiring only the use of a simple screw driver for installation, and it also serves as a faceplate for a wall-mounted electrical connection box or the like.

### BACKGROUND ART

Hanging hook devices are commonly wall-mounted for hanging various items in a building so that the various items may be hung on them for readily obtainable for use. For example, an entrance front door key and car key are often misplaced and requiring unnecessary and frustrating time to find. To eliminate such problem, it is preferable to locate them on a wall-mounted hanging hook located adjacent to the electrical switch near a front door for turning the building lights on or off so that the keys may readily be located for use and to turn off the building lights off when one is leaving the building, or to turn on the building lights on when one is returning to the building and to return the key to the hanging hook. Also, it is desirable to have personal items such as shaver and hair dryer to be hung on hanging hooks close to the electrical power outlet receptacles located adjacent to the washroom counter so that they may readily be available for use conveniently.

Hanging hook devices may be directly mounted to the wall or they can be provided on a support base or board which is mounted to the wall with securing means such as screws, or nails, or adhesive. The installation requires drilling of opening in the wall for imbedding screw anchors in the wall for securing the mounting screws, or for directly mounting the screws or nails to the wall. The installation can therefore cause damage to the wall. Furthermore, often the preferred wall location as mentioned above for mounting the hanging hook devices is not suitable for the installation of hanging hook devices due to that the wall structure can not provide the support required for the hanging hook devices installation, particularly for a wall which is covered with ceramic or mirror tiles such as commonly in a bathroom. Hanging hook devices mounted with adhesive means in the humid environment of a bathroom can deteriorate rapidly resulting in the dislocation of the hanging hook devices in a short period of time.

### SUMMARY OF THE INVENTION

It is a principal object of the present invention to provide a hanging hook device which can be conveniently mountable rigidly to a wall electrical connection box and to serve also as a faceplate for the connection box while the connection box provides the secure mounting and support at a preferred location for the hanging hook device.

It is another object of the present invention to provide a hanging hook device which may be rigidly and reliably mounted on various types of walls at commonly preferred locations.

It is another object of the present invention to provide a hanging hook device as well as a cover faceplate for various types of wall-mounted electrical connection and utility boxes.

It is yet another object of the present invention to provide a cover faceplate having integral hanging hook device thereon for easily replacing existing cover faceplate for a wall connection box containing at least one electrical switch and/or power outlet receptacle, and/or telephone, internet, and/or cable television signal outlet connection, etc.

It is still another object of the present invention to provide a cover faceplate having integral hanging hook device thereon and which may be installed easily with a simple tool.

### BRIEF DESCRIPTION OF THE DRAWINGS

Other objects and advantages of the present invention will become apparent from the following detailed description of the exemplary embodiments thereof in connection with the accompanying drawings in which

FIG. 1 is a front perspective view of the cover faceplate with an integral hanging hook device of the present invention mountable to a single wall connection box.

FIG. 2 is a front perspective view of a second embodiment of the cover faceplate of the present invention having two integral hanging hook devices thereon.

FIG. 3 is a partial sectional side perspective view showing the mounting of the cover faceplate having an integral hanging hook device of the present invention and mounted to a wall electrical connection box having an electrical on/off switch housed therein.

FIG. 4 is a front perspective view of a third embodiment of the cover faceplate of the present invention having a plurality of integral hanging hooks and is suitable for mounting to a wall connection box having a plurality of electrical devices housed within said connection box.

FIG. 5 is a front perspective view of a fourth embodiment of the cover faceplate of the present invention suitable for mounting to a wall connection box housing a signal outlet for telephone, internet, or cable television, etc.

### DETAILED DESCRIPTION OF THE PREFERRED EMBODIMENTS OF THE INVENTION

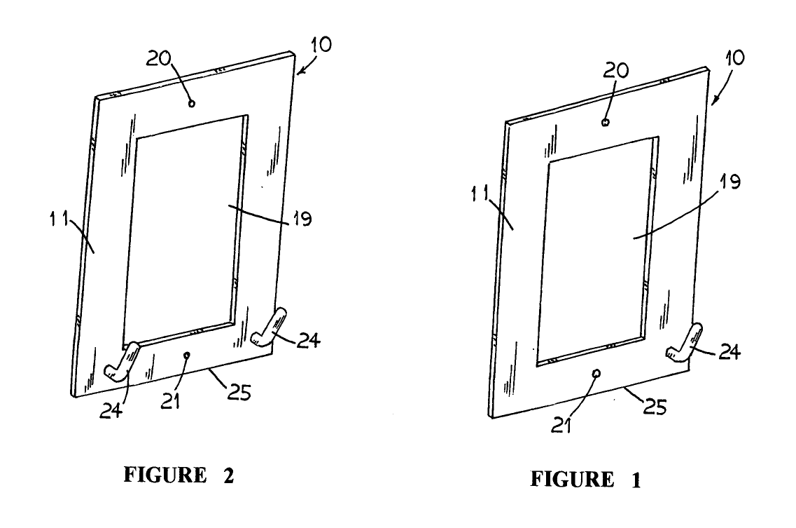

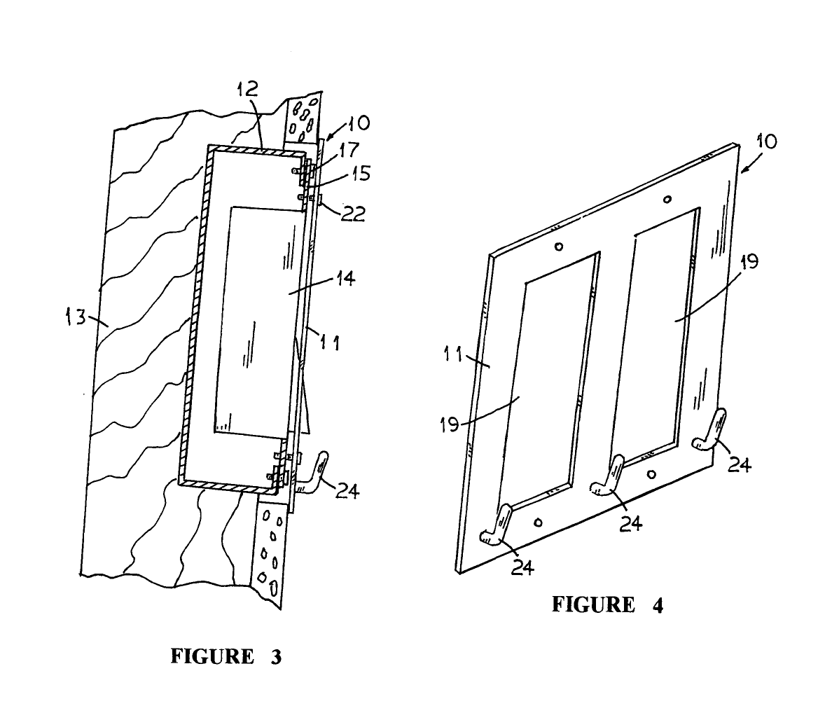

With reference to the drawings in which same reference numerals designate corresponding parts in the different views, FIG. 1 illustrates a first embodiment of the device 10 of the present invention. The device 10 comprises a plate 11 mountable, for example, to a wall electrical connection box 12 as best shown in FIG. 3. Such electrical connection box 12 is commonly made of a metal casing securely mounted to a wall stud 13 of a building. An electrical device 14 such as a light ON/OFF switch or an electrical power outlet receptacle is located in the electrical connection box 12. The electrical device 14 is provided with mounting arms 15 and 16 so that it can be securely mounted to the connection box 12 with screws 17 and 18. A central window opening 19 is formed in the plate 11. The central window opening 19 has the same shape and planar dimensions of the electrical device 14 so as to accommodate the electrical device 14 so that the operating arm or the receptacle of the electrical device 14 extends outward from the central opening 19 when the plate 11 is mounted over the connection box 12 in order to facilitate the operation of the switch or to access to the receptacle of the electrical device 14. Two mounting openings 20 and 21 are formed in the plate 11 so that the plate 11 is mountable to threaded openings formed in the mounting arms 15 and 16 of the electrical device with screws 22 and 23 so that the plate 11 is indirectly but firmly secured to the connection box 12. A hanging hook 24 is integrally formed on the lower portion of the front surface 25 of the plate 11. A simple hook is shown as an exemplary construction, it will be understood that the hanging hook 24 may have various shapes to provide the same hanging function.

The device 10 of the present invention can thus be conveniently and readily mounted to a wall connection box to serve as a cover faceplate for the connection box as well as providing hanging hook means at a wall connection box location such as that adjacent to a front door of a building at which such an electrical connection box is commonly located, or at an electrical connection box location in a bathroom adjacent to a bathroom counter. Entrance front door key and/or car key etc., may be hung on the hanging hooks at such convenient location near the front entrance door for ready access, and personal items such as hair dryer and/or electrical shaver may also be conveniently hung on the hanging hooks of the cover faceplate of the electrical connection box in the bathroom wall immediately adjacent to the bathroom counter so that these appliances can be readily connected to the electrical outlet receptacle for use. Since the device 10 is firmly secured indirectly to the wall-mounted connection box 12 which is rigidly mounted to the stud of the building, it provides a strong hanging means at such convenient locations readily without subject to the limitation of whether or not the wall at such location can support the installation of the hanging means or if the wall would be damaged by the installation.

FIG. 2 shows that more than one hanging hook 24 may be integrally formed on the plate 11.

FIG. 4 shows yet another embodiment of the device of the present invention in which the plate 11 can be used to cover a wall electrical connection box having a plurality of electrical devices mounted in the electrical connection box. The plate 11 has dimensions to cover over such wall electrical connection box and a plurality of window openings are formed in the plate 11 to accommodate the various electrical devices housed in the electrical connection box. For convenience of illustration, a plate with two window openings is shown as an exemplary construction.

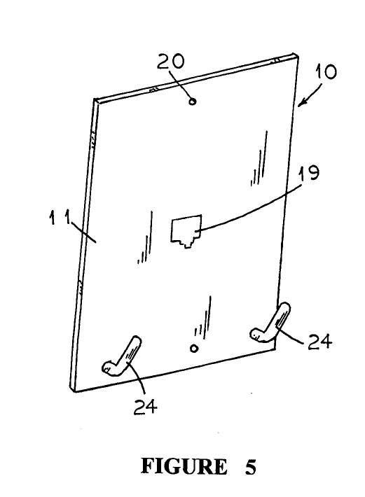

As best shown in the perspective view in FIG. 5, the device 10 may be provided with the appropriate window opening 26 to serve as a cover faceplate for a wall connection outlet for electrical signals of telephone, internet, or cable television, etc., to provide the same purposes of the present invention at the locations of these connection outlets.

The device of the present invention may be installed readily and quickly with a simple screw driver and yet it provides a rigid reliable hanging means at a commonly preferred convenient location without causing surface or structure damage to the wall and it also provides the purpose of covering the wall connection box at the location.

Various modifications can be made without departing from the spirit of this invention or the scope of the appended claims. The embodiments of the invention set forth in this disclosure are given as examples and are in no way final or binding. In view of the above, it will be seen that several objects of the invention are achieved and other advantages are obtained. As many changes could be made in the above construction without departing from the scope of the invention, it is intended that all matter contained in the above description shall be interpreted as illustrative and not in a limiting sense.

What is claimed is:

1. A faceplate and hanging hook device comprising:
a plate mountable to and covering over a wall electrical connection box fixedly mounted in a wall of a building, and said connection box having an electrical device fixedly mounted therein;
a window opening formed in said plate for accommodating and providing access to said electrical device; and
a hanging hook device formed on a surface portion of said plate.

2. A faceplate and hanging hook device according to claim 1 wherein said hanging hook is formed integrally at a lower portion of a front surface of said plate.

3. A faceplate and hanging hook device according to claim 2 including additional mounting openings formed in said plate, and said plate being mountable with mounting screws, at said mounting openings, to said electrical device located in said connection box.

4. A faceplate and hanging hook device according to claim 3 wherein said electrical connection box is fixedly mounted to a stud of said building, and said electrical device is an electrical on/off switch.

5. A faceplate and hanging hook device according to claim 3 wherein said electrical connection box is fixedly mounted to a stud of said building, and said electrical device is an electrical outlet receptacle.

6. A faceplate and hanging hook device according to claim 3 wherein said electrical connection box is fixedly mounted to a stud within said wall of said building, and said electrical device is a wall connection outlet of an electrical signal.

7. A faceplate and hanging hook device comprising:
a plate mountable to a wall electrical connection box in a building having a variety of electrical devices fixedly mounted within said box;
a plurality of window openings formed in said plate for accommodating and providing access to said electrical devices;
mounting openings formed in said plate, and said plate being mountable with screws adapted at said mounting openings for mounting said plate to said electrical devices; and
a plurality of hanging hooks formed integrally on a lower portion of a front surface of said plate.

8. A faceplate and hanging hook device according to claim 7 wherein said window openings have same shape and planar dimensions of said electrical devices mounted within said electrical connection box.

9. A faceplate and hanging hook device according to claim 7 wherein said electrical devices include electrical on/off switches, electrical outlet receptacle, and electrical signals outlet connection.

10. A faceplate and hanging hook device according to claim 7 wherein said electrical devices is a connection outlet for electrical signals from the group of devices consisting of:
telephone, internet, and cable television.
